(19) United States
(12) Patent Application Publication
(10) Pub. No.: US 2019/0315446 A1
(43) Pub. Date: Oct. 17, 2019

(54) UNDERWATER MOVING VEHICLE

(71) Applicants: KABUSHIKI KAISHA TOSHIBA, Minato-ku (JP); Toshiba Energy Systems & Solutions Corporation, Kawasaki-shi (JP)

(72) Inventors: Tomoyuki ITO, Yokohama (JP); Koichi SOMA, Yokohama (JP)

(73) Assignees: KABUSHIKI KAISHA TOSHIBA, Minato-ku (JP); Toshiba Energy Systems & Solutions Corporation, Kawasaki-shi (JP)

(21) Appl. No.: 16/301,695

(22) PCT Filed: Apr. 19, 2017
(86) PCT No.: PCT/JP2017/015744

§ 371 Date: Nov. 14, 2018

(30) Foreign Application Priority Data
May 16, 2016 (JP) 2016-098045

(51) Int. Cl. B63H 5/15; B63C 11/48; B63H 5/10; G21C 17/013; G21C 17/01

(52) U.S. Cl. CPC B63H 5/15; B63C 11/48; G21C 17/01; G21C 17/013; B63H 5/10

(57) ABSTRACT

The present invention provides an underwater moving vehicle improved in motion performance and capable of stably maintaining its position.

[Solution]

An underwater moving vehicle comprising: a vehicle body (1) configured to be set in advance in such a manner that weight of the vehicle body (1) becomes larger than buoyant force generated in water; a thruster (32) configured to generate an upward thrust by driving screw propellers (21); a drive adjuster (50) configured to control water depth of the vehicle body (1) to a predetermined position by adjusting drive of the screw propellers (21) and generating the upward thrust equivalent to difference between the weight and the buoyant force; and a water flow deflector (34) configured to move the vehicle body (1) in a horizontal direction by deflecting a downward water flow generated by the screw propellers (21).

### FIELD

Embodiments of the present invention relate to an underwater mobile vehicle capable of moving horizontally in water.

### BACKGROUND

Conventionally, a small underwater vehicle is used for investigation of a narrow space such as the interior of a nuclear reactor pressure vessel. Such a vehicle includes two screw propellers for forward and backward movement and further two screw propellers for raising and lowering. By driving these screw propellers, the vehicle moves forward, rearward, upward and downward, and turns.

### PRIOR ART DOCUMENT

[Patent Document]

[PTL 1] Japanese Unexamined Patent Application Publication No. 2008-261807

[PTL 2] Japanese Unexamined Patent Application Publication No. H07-69284

### SUMMARY

### Problem to be Solved by the Invention

In the aforementioned technique, small screw propellers must be used in order to arrange the four screw propellers within the limited dimension of the small housing. Since these screw propellers are small in size, the thrust is weak and the motion performance is deteriorated. Further, in order for the vehicle to be propelled even when the thrust of the screw propellers is weak, the weight is adjusted in such a manner that the vehicle is in a floating state (i.e., neutral buoyancy) in water. For this reason, there is a problem that the vehicle is susceptible to the influence of the cable and/or the surrounding water current and thus the position of the vehicle cannot be stably maintained under the state where the screw propellers are stopped.

In view of the above-described problems, an object of embodiments of the present invention is to provide an underwater moving vehicle that is improved in motion performance and can stably keep its position.

### Means for Solving the Problem

In one embodiment of the present invention, an underwater moving vehicle comprising: a vehicle body configured to be set in advance in such a manner that weight of the vehicle body becomes larger than buoyant force generated in water; a thruster configured to generate an upward thrust by driving screw propellers; a drive adjuster configured to control water depth of the vehicle body to a predetermined position by adjusting drive of the screw propellers and generating the upward thrust equivalent to difference between the weight and the buoyant force; and a water flow deflector configured to move the vehicle body in a horizontal direction by deflecting a downward water flow generated by the screw propellers.

In one embodiment of the present invention, an underwater moving vehicle comprising: a vehicle body configured to be set in advance in such a manner that weight of the vehicle body becomes smaller than buoyant force generated in water; a thruster configured to generate a downward thrust by driving screw propellers; a drive adjuster configured to control water depth of the vehicle body to a predetermined position by adjusting drive of the screw propellers and generating the downward thrust equivalent to difference between the weight and the buoyant force; and a water flow deflector configured to move the vehicle body in a horizontal direction by deflecting an upward water flow generated by the screw propellers.

### Effects of the Invention

According to embodiments of the present invention, it is possible to provide an underwater moving vehicle that is improved in motion performance and can stably keep its position.

### BRIEF DESCRIPTION OF THE DRAWINGS

FIG. 1 is a diagram illustrating a reactor pressure vessel under inspection with the use of an underwater moving vehicle.

FIG. 2 is a view illustrating the underwater moving vehicle of the first embodiment as viewed obliquely from above.

FIG. 3 is a view illustrating the underwater moving vehicle in the state of moving forward as viewed obliquely from above.

FIG. 4 is a side view illustrating the internal structure of the underwater moving vehicle.

FIG. 5 is a perspective view illustrating contra-rotating propellers.

FIG. 6 is a cross-sectional view illustrating a guide vane driver and a guide vane.

FIG. 7 is a plan view illustrating the guide vanes under the state where the underwater moving vehicle is stopped.

FIG. 8 is a plan view illustrating the guide vanes under the state where the underwater moving vehicle is moving forward.

FIG. 9 is a plan view illustrating the guide vanes under the state where the underwater moving vehicle is turning.

FIG. 10 is a block diagram illustrating the underwater moving vehicle and other components.

FIG. 11 is a flowchart illustrating an underwater movement processing.

FIG. 12 is a view illustrating the underwater moving vehicle of the second embodiment as viewed obliquely from below.

FIG. 13 is a view illustrating the underwater moving vehicle in the state of moving forward as viewed obliquely from below.

FIG. 14 is a side view illustrating the internal structure of the underwater moving vehicle.

FIG. 15 is a flowchart illustrating an underwater movement processing.

FIG. 16 is a side view illustrating the internal structure of the underwater moving vehicle of the third embodiment.

FIG. 17 is a side view illustrating the underwater moving vehicle in the state of moving forward.

FIG. 18 is a block diagram illustrating the underwater moving vehicle and other components.

FIG. 19 is a flowchart illustrating an underwater movement processing.

### DESCRIPTION OF EMBODIMENTS

### First Embodiment

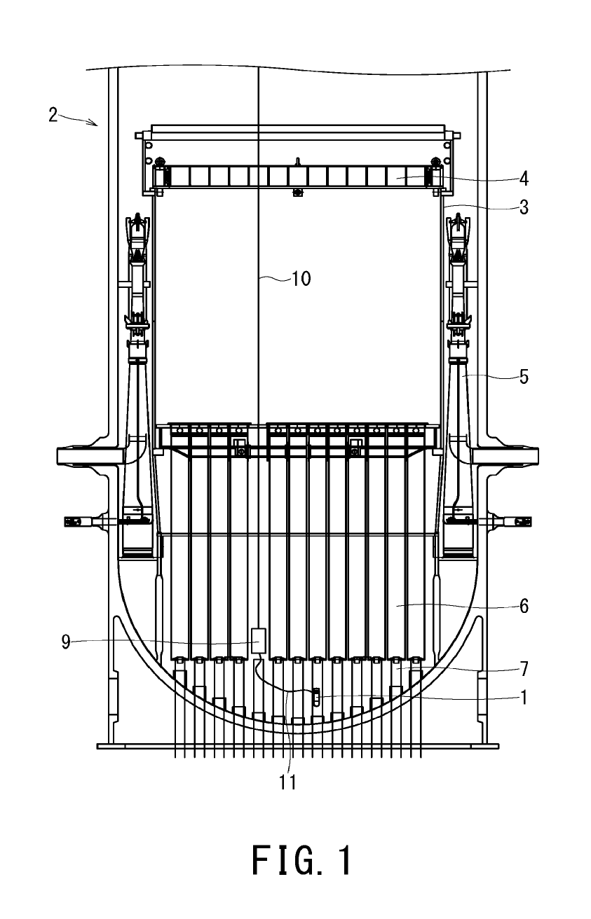

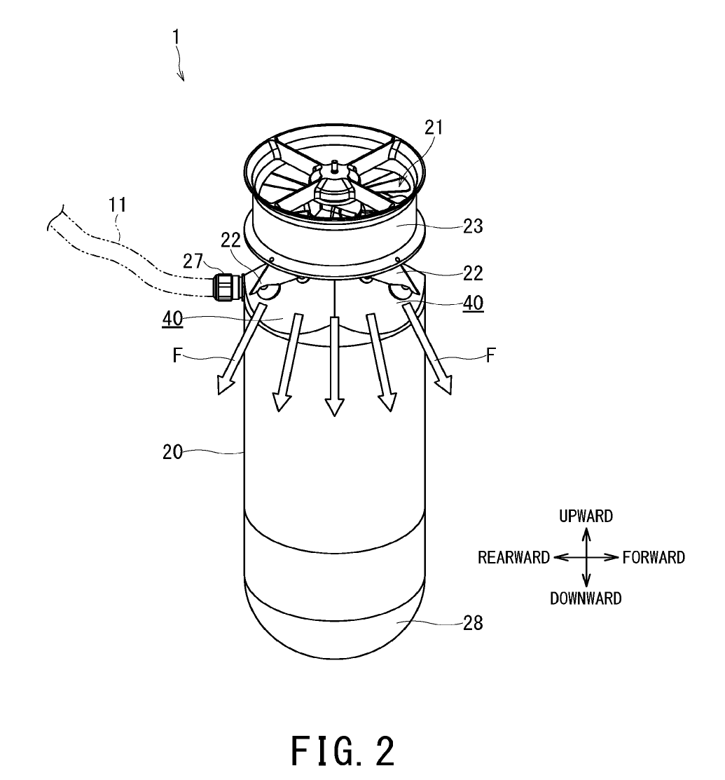

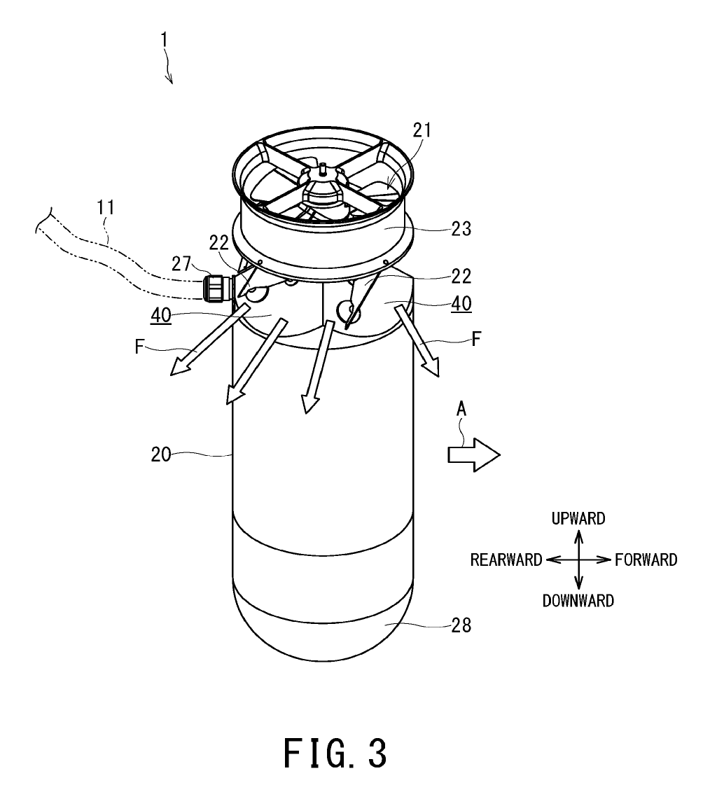

Hereinafter, embodiments of the present invention will be described by referring to the accompanying drawings. First, the underwater moving vehicle of the first embodiment will be described by referring to FIG. 1 to FIG. 11. In the following description, it is assumed that the right side of the sheet of each of FIG. 2 and FIG. 3 is the front side (i.e., anterior side) of the underwater moving vehicle 1.

The reference sign 1 in FIG. 1 is the underwater moving vehicle of the first embodiment. This underwater mobile vehicle 1 inspects and investigates the reactor pressure vessel 2. Although the underwater moving vehicle 1 is used for inspecting the reactor pressure vessel 2 of a boiling water reactor (BWR) which is one case of a nuclear power plant in the present embodiment, the underwater moving vehicle 1 may be used for inspecting a pressurized water reactor (PWR) and other types of nuclear reactors.

As shown in FIG. 1, the reactor pressure vessel 2 accommodates components such as a core shroud 3 that surrounds a non-illustrated fuel assembly constituting a core, a core support portion 4 for supporting the fuel assembly, and a jet pump 5 for generating a water flow inside the reactor pressure vessel 2, in its inside. The fuel assembly is detached from the inside of the reactor pressure vessel 2 before inspection of the reactor pressure vessel 2 or the like. The lower portion of the reactor pressure vessel 2 houses a control rod guide pipe 6 configured to guide a non-illustrated control rod for controlling the chain reaction of nuclear fuel, a control rod driving mechanism 7 for driving the control rod, and the like.

In the case of executing inspection of the reactor pressure vessel 2 or the like, a non-illustrated lid on the upper portion of the reactor pressure vessel 2 is detached and the fuel assembly and the like are moved to the nuclear fuel pool. Further, under the state where the inside of the reactor pressure vessel 2 is filled with water, the underwater moving vehicle 1 is submerged. Note that the underwater moving vehicle 1 can perform imaging (visual inspection) of a structure (i.e., target object) at the furnace bottom portion of the reactor pressure vessel 2 such as a welded portion of the housing of the control rod drive mechanism V.

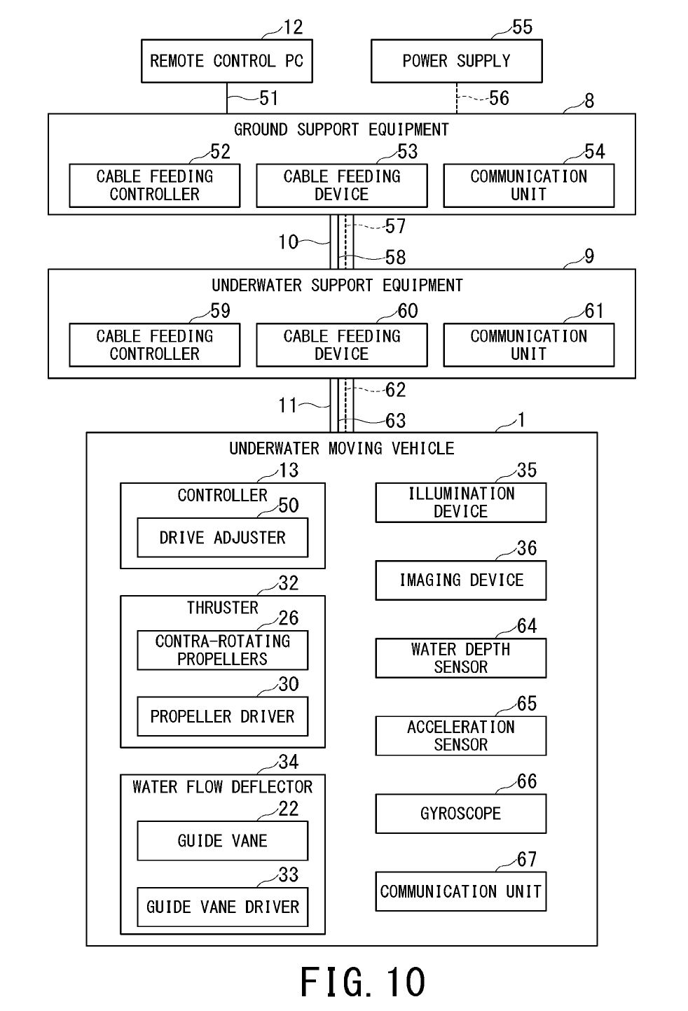

In the present embodiment, ground support equipment 8 (FIG. 10) constituted by a gantry crane and the like is provided above the reactor pressure vessel 2. The ground support equipment 8 suspends underwater support equipment 9 configured to support the underwater moving vehicle 1 with a cable 10. Further, the ground support equipment 8 lowers the underwater support equipment 9 into the water by sending out the cable 10, and then starts the underwater moving vehicle 1 from the underwater support equipment 9.

Further, the underwater support equipment 9 is a device having a vertically elongated cylindrical shape and can accommodate the underwater moving vehicle 1 inside. In addition, an opening is provided on the bottom surface of the underwater support equipment 9. After the underwater support equipment 9 is submerged in the water, the underwater moving vehicle 1 is sent out from the opening on the bottom surface. The underwater support equipment 9 and the underwater moving vehicle 1 are connected by a cable 11. Further, after completion of the inspection, the underwater support equipment 9 winds the cable 11 to accommodate the underwater moving vehicle 1. Afterward, the underwater moving vehicle 1 is pulled up by the ground support equipment 8, in the state of being housed in the underwater support equipment 9.

The underwater moving vehicle 1 of the present embodiment is a device which can be operated remotely. An operator operates the underwater moving vehicle 1 by using the remote control PC (FIG. 10) provided on the ground. The operation signal transmitted from the remote control PC 12 is transmitted to the underwater moving vehicle 1 via the cables 10 and 11.

Note that the operation signal transmitted from the remote control PC 12 is transmitted to the underwater moving vehicle 1 via the cables 10 and 11. In addition, image signals acquired by using the underwater moving vehicle 1 are transmitted to the remote control PC 12 via the cables 10 and 11. Further, the underwater moving vehicle 1 includes a controller 13 (FIG. 10) that controls the underwater moving vehicle 1 on the basis of the operation signals transmitted from the remote operation PC 12 and detection signals of various sensors.

As shown in FIG. 2, the underwater moving vehicle 1 has a housing 20 having a vertically elongated cylindrical shape. The housing 20 is made of a material such as a synthetic resin, and has an enclosed space for accommodating various devices therein. The housing 20 may be made of a material such as metal. Additionally or alternatively, a part of the housing 20 may be made of a metal material and the other parts may be formed of a synthetic resin.

Further, screw propellers 21 are arranged on the upper part of the housing 20. In the first embodiment, by driving the screw propellers 21, a downward water flow F is generated in order to generate an upward thrust with respect to the underwater moving vehicle 1, i.e., a thrust of raising the underwater moving vehicle 1.

The underwater moving vehicle 1 (vehicle body) of the first embodiment is preliminarily set in such a manner that its weight is larger than the buoyant force generated in water. By adjusting the drive of the screw propellers 21 and generating the upward thrust equivalent to the difference between the weight and the buoyant force, the water depth of the underwater moving vehicle 1 can be kept constant. In other words, the underwater moving vehicle 1 can perform hovering in the water. Further, when the rotation speed of the screw propellers 21 is increased, the underwater moving vehicle 1 is raised. Conversely, when the rotation speed of the screw propellers 21 is decreased, the underwater moving vehicle 1 is lowered.

The underwater moving vehicle 1 of the first embodiment is provided with screw propellers 21 (main thruster) for generating the upward thrust, i.e., thrust only in one direction, and does not include a screw propeller (sub thruster) for generating a thrust in another direction, e.g., the front-and-rear direction and/or the right-and-left direction. When the underwater moving vehicle 1 of the first embodiment generates a thrust force in the front-and-rear direction and/or the right-and-left direction, the guide vanes 22 are moved.

In the first embodiment, four guide vanes 22 are provided directly under the screw propellers 21. By changing the direction of these guide vanes 22, the downward water flow F generated by the screw propellers 21 is deflected. For instance, when the downward water flow F generated by the screw propellers 21 is deflected in one of the front, rear, left, and right directions, the underwater moving vehicle 1 can be moved in the direction A opposite to the deflected direction (FIG. 3).

Further, on the upper portion of the housing 20, a Kort nozzle 23 surrounding the periphery of the screw propellers 21 is provided. The Kort nozzle 23 is a device having a cylindrical shape fixed to the upper portion of the housing 20. The Kort nozzle 23 generates a lift force by the water flow F that is generated by the rotation of the screw propellers 21. By obtaining this lift force, the thrust generated by the screw propellers 21 can be increased. Further, the Kort nozzle 23 can protect the screw propellers 21 by preventing the screw propellers 21 from being brought into contact with an obstacle.

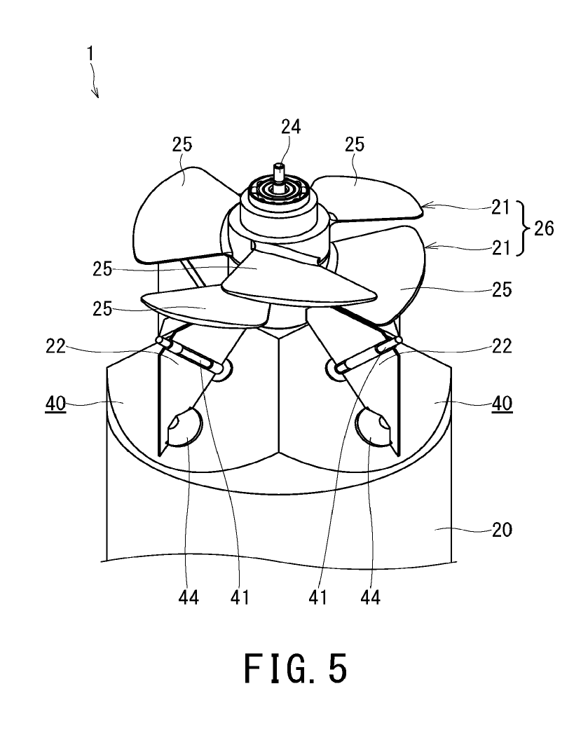

FIG. 5 is a perspective view of the screw propellers 21. In FIG. 5, the structure of the Kort nozzle 23 or the like is omitted for the sake of understanding. As shown in FIG. 5, the screw propellers 21 are provided at the upper end portion of the housing 20. Further, the rotation shaft 24 of the screw propellers 21 is oriented in the vertical direction. Three blades 25 are provided around the rotation shaft 24 to constitute one set of screw propellers 21.

The screw propellers 21 of the present embodiment constitute contra-rotating propellers 26 in which two sets of the screw propellers 21 are coaxially arranged and rotate in the respective directions opposite to each other. For instance, the upper screw propeller 21 rotates in the clockwise direction in plan view, and the lower screw propeller 21 rotates in the counterclockwise direction in plan view. By providing such contra-rotating propellers 26, the reaction force (torque) received by each screw propeller 21 from water can be canceled and the rotational energy can be recovered, and thus the propulsion efficiency can be improved. Furthermore, it is possible to suppress the water flow F generated by each set of the screw propellers 21 from spreading in a spiral shape and to generate the water flow F having straightness.

In the present embodiment, the screw propellers 21 having a large rotation diameter can be used. Thus, a large thrust can be generated. Note that the diameter of the Kort nozzle 23 is substantially the same as the diameter of the housing 20. Thus, even in the narrow internal environment of the reactor pressure vessel 2 that is restricted in terms of the arrangement of the screw propellers, it is possible to miniaturize the underwater moving vehicle in the horizontal direction by arranging the screw propellers in the vertical direction of the underwater moving vehicle.

In the present embodiment, the diameter of the screw propellers 21 is made substantially equal to the diameter of the housing 20 such that the underwater moving vehicle 1 can be advanced even in a narrow space. Further, when the space to be progressed is sufficiently wide, the diameter of the screw propellers 21 may be larger than the diameter of the housing 20.

In the present embodiment, even when the underwater moving vehicle 1 is made compact, large screw propellers 21 can be mounted and thus a large thrust can be generated. In addition, a relatively large thrust can be obtained against the flow of water occurring around the underwater moving vehicle 1, and the position of the underwater moving vehicle 1 can be stably maintained.

As shown in FIG. 2, on the outer peripheral surface of the housing 20, a cable connecting portion 27 to which the cable 11 is connected is provided on the rear surface side of the underwater moving vehicle 1. In addition, a window portion 28 having a hemispherical shape is provided under the housing 20. The window portion 28 is formed of a transparent material such as acrylic resin or glass and is formed so as to withstand a predetermined water pressure. The inside of the underwater moving vehicle 1 is a space sealed by the window portion 28 and the housing 20. When this underwater moving vehicle 1 submerges in water, the underwater moving vehicle pushes water out and thereby the buoyant force occurs.

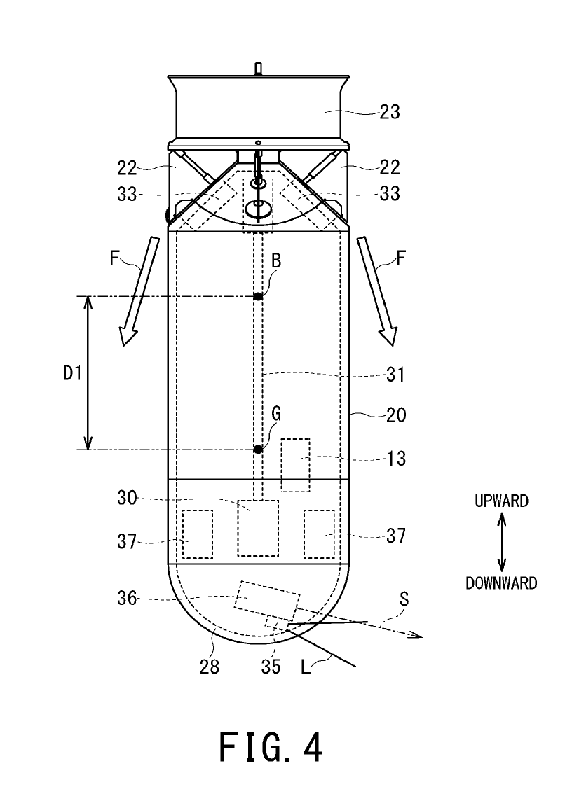

As shown in FIG. 4, a propeller driver 30 configured to rotatably drive the screw propellers 21 is accommodated in the lower portion inside the housing 20. In addition, a drive shaft 31 for transmitting the power of the propeller driver 30 to the screw propellers 21 is provided. Although it is not illustrated in detail, the propeller driver 30 has two drive motors for driving the respective two sets of the screw propellers 21. In addition, the drive shaft 31 has a hollow shaft having a cavity therein and a solid shaft arranged in the cavity of the hollow shaft. Further, the motive power of each drive motor is transmitted to each screw propeller 21 by the hollow shaft and the solid shaft. Incidentally, the contra-rotating propellers 26 and the propeller driver 30 constitute a thruster 32 (FIG. 10).

Four guide vane drivers 33 are accommodated in the upper portion of the interior of the housing 20 in order to drive the four guide vanes 22. The four guide vanes 22 and the four guide vane drivers 33 constitute a water flow deflector 34 of the first embodiment (FIG. 10).

Further, an illumination device 35 and an imaging device 36 are provided on the lower side of the interior of the housing 20. The illumination device 35 irradiates an underwater target object with illumination light L, and the imaging device 36 images the target object. The imaging device 36 can perform inspection and investigation of the underwater target object by imaging the target object through the window portion 28. Further, the illumination device 35 is fixed to the imaging device 36. Moreover, the imaging device 36 can swing vertically and laterally, and can change its imaging direction S within a predetermined range. Note that the controller 13 for controlling various devices such as the imaging device 36 is housed inside the housing 20.

Moreover, adjustment weights 37 for adjusting the weight of the underwater moving vehicle 1 are provided on the lower side inside the housing 20. The adjustment weights 37 are detachable. Several adjustment weights 37 of different weights are prepared, and the weight of the underwater moving vehicle 1 can be adjusted by the adjustment weights 37 before using the underwater moving vehicle 1.

A description will be given of one case of how to adjust the weight of underwater moving vehicle 1. For instance, the underwater moving vehicle 1 with predetermined adjustment weights 37 attached thereto is put into a test pool. When the underwater moving vehicle 1 sinks, a lightweight adjustment weight 37 is replaced. Conversely, when the underwater moving vehicle 1 floats, a heavy adjustment weight 37 is replaced. By repeating this, the underwater moving vehicle 1 is adjusted by the adjustment weights 37 so that the underwater moving vehicle 1 is in a floating state (neutral buoyancy) in water.

Further, under the state where the underwater moving vehicle 1 is in the neutral buoyant force, the underwater moving vehicle 1 is lifted from underwater and its weight is measured. This measured value is the buoyant force generated for the underwater moving vehicle 1. Further, in order to add weight to this measured value, an adjustment weight 37 of a specific weight is additionally attached to the underwater moving vehicle 1.

When the buoyant force occurring in the underwater moving vehicle 1 is 10 kg, an adjustment weight 37 is added such that the weight of the underwater moving vehicle 1 becomes 10.5 kg. That is, an adjustment weight 37 is added in such a manner that the weight of the underwater moving vehicle 1 is larger than the buoyant force by 5%. For instance, the upward thrust generated by driving the screw propellers 21 (contra-rotating propellers 26) is assumed to be 1 kg at the maximum. In this case, when the thrust generated at the time of reducing the thrust of the screw propellers 21 to 50% is assumed to be about half (i.e., 0.5 kg), the adjustment weight 37 having a weight corresponding to 0.5 kg is added.

In other words, in the underwater moving vehicle 1 of the first embodiment, when the thrust of the screw propellers 21 (contra-rotating propellers 26) is set to 50%, an upward thrust corresponding to the difference between the weight and the buoyant force can be generated. In this state, the underwater moving vehicle 1 does not float or sink and can keep its water depth constant. Further, when the thrust of the screw propellers 21 is made larger than 50%, an upward thrust exceeding the difference between the weight and the buoyant force can be generated, and thus the underwater moving vehicle 1 can be raised. When the thrust of the screw propellers 21 is made smaller than 50%, an upward thrust smaller than the difference between the weight and the buoyant force can be generated, and thus the underwater moving vehicle 1 can be lowered. In this manner, by controlling the driving of the screw propellers 21, it is possible to control the ascent and descent of the underwater moving vehicle 1.

In the first embodiment, to reduce the thrust of the screw propellers 21 (contra-rotating propellers 26) to less than 50%, i.e., to generate an upward thrust smaller than the difference between the weight and the buoyant force includes stopping the driving (rotation) of the screw propellers 21 and setting the thrust to 0% (not generating a thrust).

In the first embodiment, the weight of the underwater moving vehicle 1 is made larger than the buoyant force. Consequently, when the underwater moving vehicle 1 fails and the driving of the screw propeller 21 stops, the underwater moving vehicle 1 sinks. In particular, when the underwater moving vehicle 1 fails during inspection of the furnace bottom portion of the reactor pressure vessel 2 and then inadvertently emerges, there is a risk that the reactor pressure vessel 2 gets into the gap of other structures of the reactor pressure vessel 2. In the present embodiment, since the underwater moving vehicle 1 is set to sink in the event of a failure, it is possible to easily recover the underwater moving vehicle 1.

Although the weight of the underwater moving vehicle 1 is made 5% larger than the buoyant force in the first embodiment, it is sufficient that the weight of the underwater moving vehicle 1 is at least 3% larger than the buoyant force. By satisfying this condition, even when the water depth of the underwater moving vehicle 1 is kept constant, the thrust of the screw propellers 21 (contra-rotating propellers 26) corresponding to the difference between the weight and the buoyant force is continuously applied to the underwater moving vehicle 1, and thus the position of the underwater moving vehicle 1 can be stably maintained. In other words, the underwater moving vehicle 1 is pulled downward by gravity equivalent to the difference between its weight and the buoyant force and is pushed up by the upward thrust of the same force. Since such force is continuously applied to the underwater moving vehicle 1, its position can be kept stably.

The difference between the weight of the underwater moving vehicle 1 and the buoyant force may be appropriately changed according to the thrust of the screw propellers 21. For instance, the weight of the underwater moving vehicle 1 may be larger than the buoyant force by 10%, 20%, or 30%. In addition, the difference between the weight of the underwater moving vehicle 1 and the buoyant force is not required to be a value corresponding to 50% of the thrust of the screw propellers 21. For instance, the difference between the weight of the underwater moving vehicle 1 and the buoyant force may be a value corresponding to 30%, 40%, 60%, 70%, or 80% of the thrust of the screw propellers 21.

As shown in FIG. 4, the gravity center G of the underwater moving vehicle 1 is located on the lower side of the housing 20 by the weight of the propeller driver 30 and the adjustment weights 37. It should be noted that the gravity center G and the center B of buoyancy are spaced apart by a predetermined distance D1.

The underwater moving vehicle 1 of the present embodiment maintains the rotation shaft 24 of the screw propellers 21 in the vertical direction by locating the gravity center G below the center B of buoyancy. By configuring it in this manner, even when the water flow F generated by the screw propellers 21 is deflected, the restoring force for maintaining the attitude of the underwater moving vehicle 1 works so that the rotation shaft 24 of the screw propellers 21 becomes vertical, and thus the underwater moving vehicle 1 can be stably moved in the horizontal direction.

Although the weight to be added is adjusted by the adjustment weights 37 with reference to the buoyant force of the underwater moving vehicle 1 in the present embodiment, the buoyant force may be adjusted by the adjustment weights 37 on the basis of the weight of the underwater moving vehicle 1. Further, the buoyant force of the underwater moving vehicle 1 may be at least 3% smaller than its weight.

Although the adjustment weights 37 are used for adjusting the weight and the buoyant force of the underwater moving vehicle 1 in the present embodiment, the weight and the buoyant force of the underwater moving vehicle 1 may be adjusted by another method. For instance, increase or decrease of the buoyant force of the underwater moving vehicle 1 may be adjusted by using a detachable adjustment float.

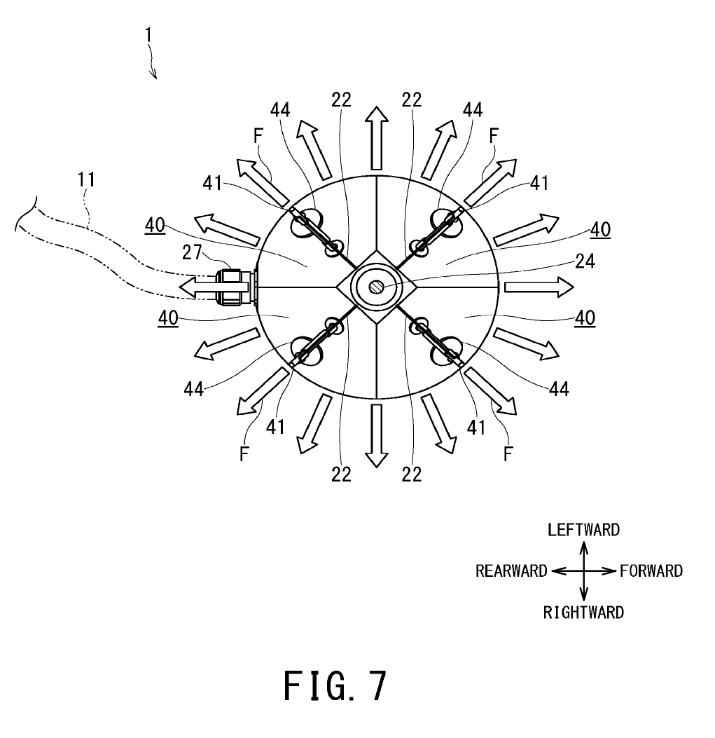

As shown in FIG. 5 and FIG. 7, the upper portion of the housing 20 is formed in a pyramidal shape (quadrangular pyramidal shape). In the present embodiment, guide vanes 22 are arranged one by one on each of the four sides of the right front, the left front, the right rear, and the left rear. These four surfaces constitute the arrangement surfaces 40 of the guide vanes 22. The arrangement surfaces 40 are flat surfaces having an inclination of 45°. In addition, the arrangement surfaces 40 are fan-shaped surfaces corresponding to the swinging range of the guide vanes 22. Further, vertically extending support rods 41 are provided on the respective arrangement surfaces 40. The guide vanes 22 are swingably supported by the support rods 41.

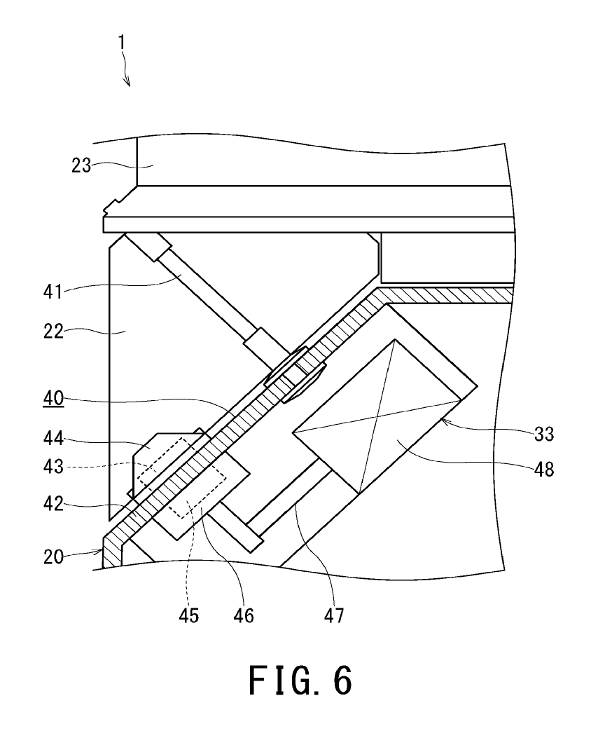

As shown in FIG. 6, the guide vanes 22 are plate members having a triangular shape in side view. Further, the guide vanes 22 are provided between the Kort nozzle 23 and the arrangement surfaces 40. The water flow F generated by the screw propellers 21 is guided by the guide vanes 22 and the arrangement surfaces 40, and flows downward along the outer peripheral surface of the housing 20 (FIG. 4).

In addition, the guide vanes 22 outside the housing 20 and the guide vane drivers 33 inside the housing 20 are separated by walls 42 forming the respective arrangement surfaces 40. The walls 42 are made of a material that transmits magnetic force, such as a synthetic resin. Further, as long as it is a material that transmits magnetic force, the walls 42 may be made of a metal material such as aluminum.

Further, in the vicinity of the guide vanes 22, there are provided first magnetic-force linkage units 44, each of which has a first magnet 43. In each guide vane driver 33, a second magnetic-force linkage unit 46 having a second magnet 45 is provided at a position corresponding to the first magnetic-force linkage unit 44 via the walls 42. Each of the second magnetic-force linkage units 46 is connected to a swinging rod 47 that is provided so as to be able to swing. Each swinging rod 47 is connected to a solenoid portion 48. The swinging motion of each swinging bar 47 is controlled by the driving force of the solenoid portion 48. Each guide vane driver 33 is composed of the second magnetic-force linkage portion 46, the swinging rod 47, and the solenoid portion 48.

The first magnetic-force linkage units 44 are linked to the respective second magnetic force linkage units 46 by magnetic force. The second magnetic-force coupling linkage units 46 swing and move, and thereby the first magnetic-force linkage units 44 slide and move along the arrangement surfaces 40. By the movement of the first magnetic-force linkage units 44, the guide vanes 22 are swung around the respective support rods 41 as a shaft.

As described above, the guide vane drivers 33 are disposed inside the housing 20, and the guide vane drivers 33 and the guide vanes 22 are linked by the magnetic force transmitted through the walls 42 of the housing 20. Consequently, the guide vanes 22 can be driven while entry of water is being prevented by the housing 20.

Although each of the first magnetic-force linkage units 44 includes the first magnet 43 and each of the second magnetic-force linkage units 46 includes the second magnet 45 in the present embodiment, it is sufficient that the first magnetic-force linkage units 44 or the second magnetic-force linkage units 46 are magnetizable metal (i.e., magnetic material). In addition, the first magnetic-force linkage units 44 and the second magnetic-force linkage unit 46 may be linked to each other by using electromagnets (including a solenoid coil or the like).

As shown in FIG. 2 and FIG. 7, when the underwater moving vehicle 1 is not moved in the horizontal direction but is stopped there, the four guide vanes 22 are oriented to extend radially in plan view. In this case, since the water flow F generated by the screw propellers 21 radially flows in plan view, the underwater moving vehicle 1 does not move in any of the front, rear, right, and left directions and can stay there.

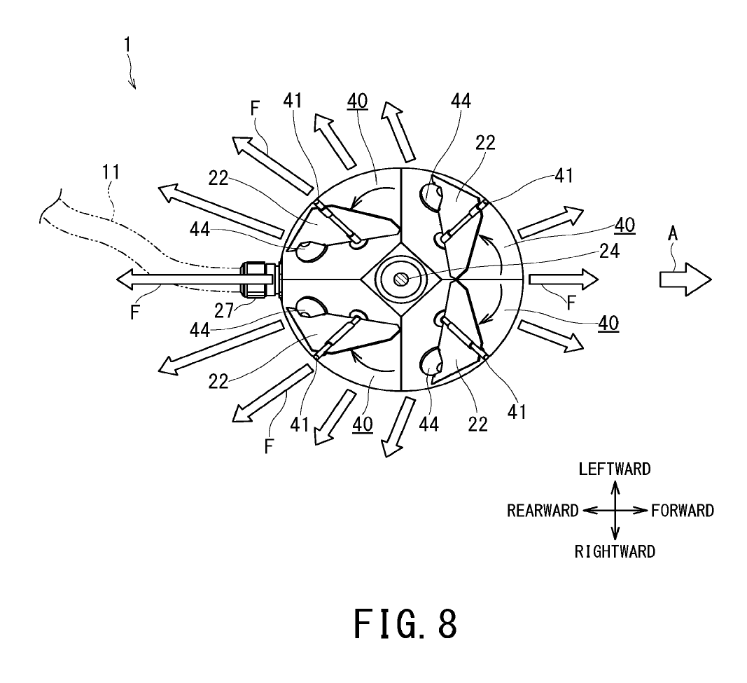

As shown in FIG. 3 and FIG. 8, when the underwater moving vehicle 1 is moved forward, the two left guide vanes 22 are swung counterclockwise in plan view and the two right guide vanes 22 are swung clockwise in plan view. In this case, since the water flow F generated by the screw propellers 21 flows in a large amount to the rear side, the underwater moving vehicle 1 is moved in the opposite direction A (forward direction). Since a part of the water flow F also flows to the front side, the underwater moving vehicle 1 can be advanced without tilting the vertical axis of the underwater moving vehicle 1.

In the case of moving the underwater moving vehicle rearward, the two left guide vanes 22 are swung clockwise in plan view and the two right guide vanes 22 are swung counterclockwise in plan view.

In addition, in the case of moving the underwater moving vehicle 1 horizontally leftward, the two front guide vanes 22 are swung clockwise in plan view and the two rear guide vanes 22 are swung counterclockwise in plan view.

Conversely, in the case of moving the underwater moving vehicle 1 horizontally rightward, the two front guide vanes 22 are swung counterclockwise in plan view and the two rear guide vanes 22 are swung clockwise in plan view.

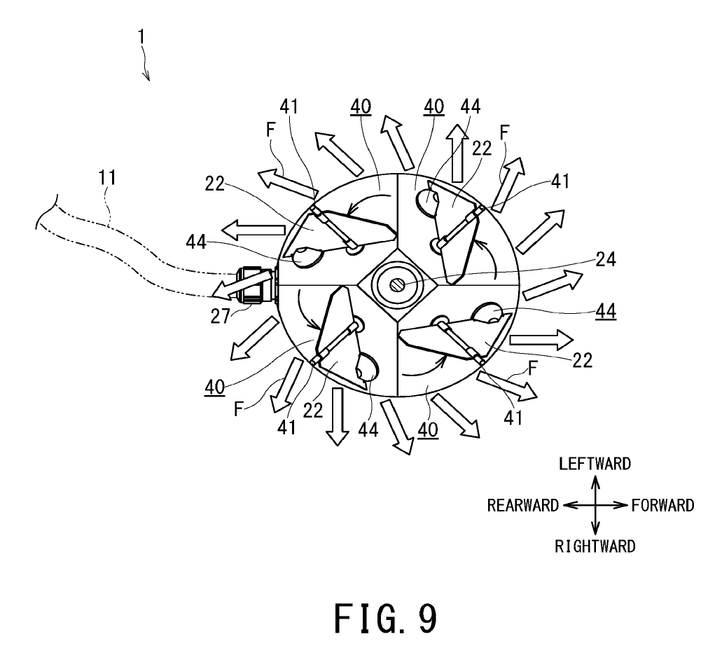

As shown in FIG. 9, in the case of turning the underwater moving vehicle 1 clockwise in plan view, the four guide vanes 22 are swung counterclockwise. In this case, since the water flow F generated by the screw propellers 21 flows counterclockwise, the underwater moving vehicle 1 is turned clockwise in plan view.

In the case of turning the underwater moving vehicle 1 counterclockwise in plan view, the four guide vanes 22 are swung clockwise. In this case, since the water flow F generated by the screw propellers 21 flows clockwise, the underwater moving vehicle 1 is turned counterclockwise in plan view.

In this manner, by deflecting the water flow F generated by the screw propellers 21 with the use of the guide vanes 22, it is possible to control the horizontal movement and turning of the underwater moving vehicle 1. Additionally, by providing the screw propellers 21 configured to generate the thrust only in one direction (upward), the underwater moving vehicle 1 can move in any direction including front, rear, right, and left. The control of the guide vanes 22 is executed by a drive adjuster 50 of the controller 13 on the basis of the operation signal transmitted from the remote operation PC 12 (FIG. 10).

Although the horizontal movement and turning of the underwater moving vehicle 1 are controlled by using the four guide vanes 22 in the present embodiment, it is sufficient that at least two guide vanes 22 are provided. For instance, it is possible to control the horizontal movement (front-and-rear movement) and the turning of the underwater moving vehicle 1 by driving the respective two guide vanes 22, which are disposed so as to face each other with the center of the housing 20 interposed therebetween in plan view. Further, three guide vanes 22 radially arranged from the center of the housing 20 in plan view may be used for controlling the horizontal movement and turning of the underwater moving vehicle 1.

Although the guide vanes 22 are used in the case of turning the underwater moving vehicle 1 in the present embodiment, the underwater moving vehicle 1 may be turned by another method. For instance, in the contra-rotating propellers 26 shown in FIG. 5, by making the respective rotation speeds of the upper and lower screw propellers 21 different from each other, it is possible to turn the underwater moving vehicle 1 around the shaft of the screw propellers 21.

First, it is assumed that the upper screw propellers 21 rotate in the clockwise direction in plan view, and the lower screw propellers 21 rotate counterclockwise in plan view. In the case of turning the underwater moving vehicle 1 clockwise in plan view, the rotation speed of the upper screw propellers 21 is decreased and the rotation speed of the lower screw propellers 21 is increased. In this case, by the reaction force of the lower screw propellers 21, it is possible to turn the underwater moving vehicle 1 clockwise in plan view.

In the case of turning the underwater moving vehicle 1 counterclockwise in plan view, the rotation speed of the upper screw propellers 21 is increased and the rotation speed of the lower screw propellers 21 is decreased. In this case, by the reaction force of the lower screw propellers 21, it is possible to turn the underwater moving vehicle 1 counterclockwise in plan view. In this manner, the turning of the underwater moving vehicle 1 can be achieved by controlling the respective rotational speeds of the screw propellers 21.

FIG. 10 is a block diagram illustrating the system configuration of the present embodiment. The nuclear reactor investigation apparatus of the present embodiment includes the ground support equipment 8, the underwater support equipment 9, and the underwater moving vehicle 1. In addition, the remote control PC 12 is provided for an operator to remotely operate the underwater moving vehicle 1 and the like. The remote control PC 12 is connected to the ground support equipment 8 via a communication line 51.

Further, the ground support equipment 8 includes a cable feeding controller 52 for controlling the feeding amount or rewinding amount of the cable 10 connected to the underwater supporting device 9, a cable feeding device 53 for feeding or rewinding the cable 10, a communication unit 54 for communicating with the remote operation PC 12. A power supply 55 for supplying electric power to various types of devices is connected to the ground support equipment 8. The power supply 55 is constituted by a generator or the like provided outdoors, and is connected to the ground support equipment 8 via a power supply line 56. The cable 10 connecting the ground support equipment 8 and the underwater support equipment 9 includes a power supply line 57 for supplying electric power to the underwater support equipment 9 and a communication line 58 for transferring operation signals and the like.

In addition, the underwater support equipment 9 includes a cable feeding controller 59 for controlling the feeding amount or rewinding amount of the cable 11 connected to the underwater moving vehicle 1, a cable feeding device 60 for feeding or rewinding the cable 11, a communication unit 61 for communicating with the remote operation PC 12. The cable 11 connecting the ground support equipment 8 and the underwater moving vehicle 1 includes a power supply line 62 for supplying electric power to the underwater moving vehicle 1 and a communication line 63 for transferring operation signals and the like.

The underwater moving vehicle 1 includes the above-described controller 13, the thruster 32, the water flow deflector 34, the illumination device 35, and the imaging device 36. The underwater moving vehicle 1 further includes a water depth sensor 64 configured to detect the depth of the underwater moving vehicle 1, an acceleration sensor 65 configured to detect the moving direction and moving speed of the underwater moving vehicle 1, a gyroscope 66 configured to detect the orientation of the underwater moving vehicle 1, a communication unit 67 configured to communicate with the remote operation PC 12. These devices are connected to and controlled by the controller 13. The controller 13 can specify the current position of the underwater moving vehicle 1 by the water depth sensor 64, the acceleration sensor 65, and the gyroscope 66.

The controller 13 includes the drive adjuster 50 configured to control the guide vanes 22. In addition, the thruster 32 includes the contra-rotating propellers 26 and the propeller driver 30. Further, the water flow deflector 34 includes the guide vanes 22 and the guide vane drivers 33.

Incidentally, the controller 13 includes hardware resources such as a processor and a memory, and is constituted of a computer in which information processing by software is achieved by causing its CPU to execute various programs with the use of hardware resources.

In addition, the water depth sensor 64 can detect the distance from the water surface to the position of the underwater moving vehicle 1 and can also detect the water pressure. The buoyant force occurring in the underwater moving vehicle 1 varies depending on the water pressure. The drive adjuster 50 of the present embodiment can keep the water depth of the underwater moving vehicle 1 constant or move the underwater moving vehicle 1 to a predetermined position, by controlling the rotation speed of the screw propellers 21 to the rotation speed corresponding to the water depth detected by the water depth sensor 64.

The drive adjuster 50 of the present embodiment store a rotation number table in the memory. This rotation number table is a table in which rotation speed of the screw propellers 21 and the water depth (water pressure) are associated with each other.

For instance, in the case of keeping the water depth of the underwater moving vehicle 1 constant, the drive adjuster 50 refers to the rotation number table and drives the screw propellers 21 at the rotation speed corresponding to the water depth detected by the water depth sensor 64.

In addition, when the underwater moving vehicle 1 goes up and down and the water depth changes, the drive adjuster 50 changes the rotation speed of the screw propellers 21 on the basis of the rotation speed table.

In this manner, even when the buoyant force occurring in the underwater moving vehicle 1 varies depending on the water depth, the rotation speed of the screw propellers 21 can be appropriately controlled and thus the position of the underwater moving vehicle 1 can be stably maintained at any water depth.

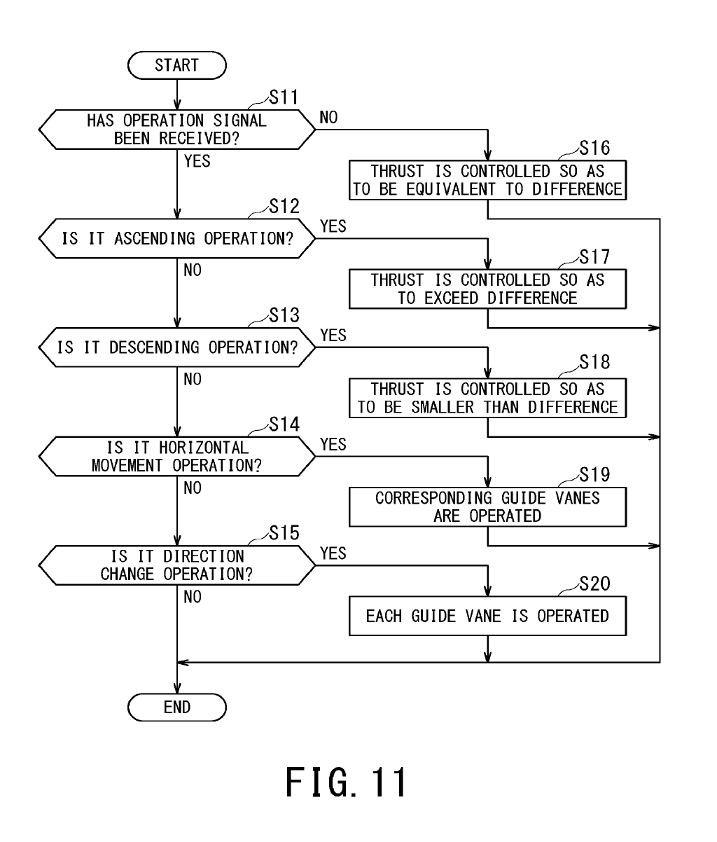

Next, a description will be given of the underwater movement processing executed by the controller 13 (drive adjuster 50) of the underwater moving vehicle 1 by referring to FIG. 11.

In the setting step, the weight of the underwater moving vehicle 1 is set in advance so as to be larger than the buoyant force generated in water in the first embodiment as described above.

In the thrust step, when the underwater moving vehicle 1 is submerged in water, the controller 13 generates an upward thrust corresponding to the difference between the weight of the underwater moving vehicle 1 and the buoyant force by driving the screw propellers 21.

In the step S11 as shown in FIG. 11, firstly, the controller 13 determines whether an operation has been received from the remote control PC or not, i.e., whether an operation signal has been received or not.

When any operation is not received from the remote control PC, in the drive adjustment step S16, the control is performed by keeping the rotation speed of the screw propellers 21 constant such that the upward thrust equivalent to the difference between the weight of the underwater moving vehicle 1 and the buoyant force is maintained and the water depth of the underwater moving vehicle 1 is kept constant. Then, the underwater movement processing is completed.

Conversely, when an operation is received from the remote operation PC, the processing proceeds to the step S12.

In the step S12, the controller 13 determines whether the received operation is an ascending operation or not.

When the received operation is the ascending operation, in the step S17, the control is performed by increasing the rotation speed of the screw propellers 21 such that the upward thrust exceeding the difference between the weight of the underwater moving vehicle 1 and the buoyant force is generated and thereby the underwater moving vehicle 1 is raised. Then, the underwater movement processing is completed.

Conversely, when the received operation is not the ascending operation, the processing proceeds to the step S13.

In the step S13, the controller 13 determines whether the received operation is a descending operation or not. When the received operation is the descending operation, in the step S18, the control is performed by decreasing the rotation speed of the screw propellers 21 such that the upward thrust smaller the difference between the weight of the underwater moving vehicle 1 and the buoyant force is generated and thereby the underwater moving vehicle 1 is lowered. Then, the underwater movement processing is completed.

Conversely, when the received operation is not the descending operation, the processing proceeds to the step S14.

In the step S14, the controller 13 determines whether or not the received operation is a horizontal movement operation, i.e., an operation to move the underwater moving vehicle 1 in any one of the front, rear, right, and left directions.

When the received operation is the horizontal movement operation, in the water flow deflection step S19, the corresponding guide vanes 22 are operated. For instance, in the case of moving the underwater moving vehicle 1 forward, the two left guide vanes 22 are swung counterclockwise in plan view and the two right guide vanes 22 are swung clockwise in plan view (FIG. 8). Then, the underwater movement processing is completed. When the operation signal of the horizontal movement operation is continuously received, the operation of the guide vanes 22 is continued.

Conversely, when the received operation is not the horizontal movement operation, the processing proceeds to the step S15.

In the step S15, the controller 13 determines whether the received operation is a direction change operation, i.e., it is an operation to turn the underwater moving vehicle 1 or not. When the received operation is the direction change operation, in the step S20, each guide vane 22 is operated. For instance, in the case of turning the underwater moving vehicle 1 clockwise in plan view, the four guide vanes 22 are swung counterclockwise (FIG. 9). Then, the underwater movement processing is completed. When the operation signal of the direction change operation is continuously received, the operation of the guide vanes 22 is continued.

Conversely, when the received operation is not the direction change operation, the underwater movement processing is completed.

### Second Embodiment

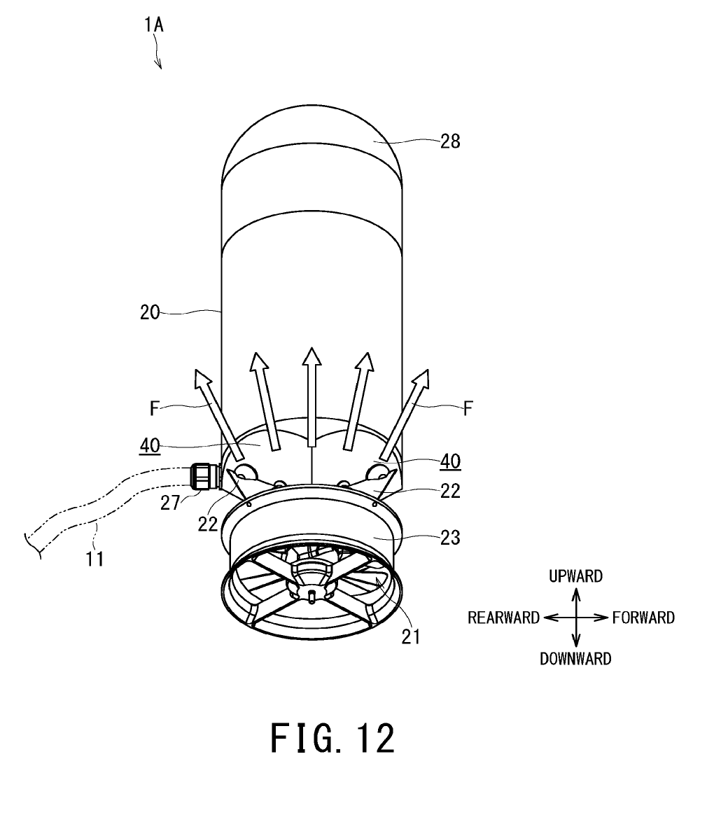

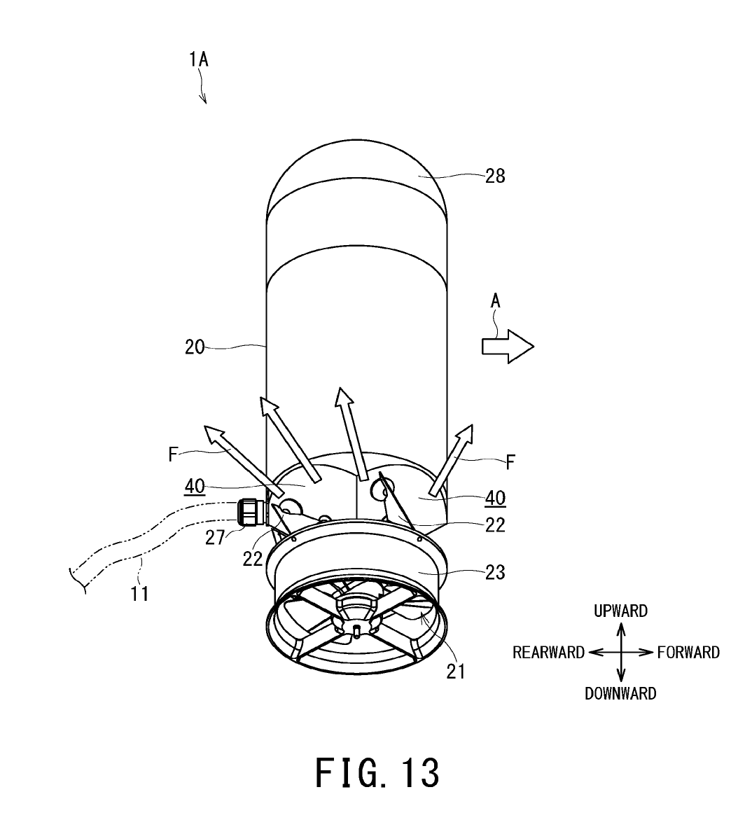

Next, the underwater moving vehicle 1A of the second embodiment will be described by referring to FIG. 12 to FIG. 15. Note that the same reference signs are assigned to the same components as the above-described embodiment, and duplicate description is omitted. In the following description, it is assumed that the right side of the sheet of each of FIG. 12 and FIG. 13 is the front side (i.e., anterior side) of the underwater moving vehicle 1A.

As shown in FIG. 12, the underwater moving vehicle 1A of the second embodiment has a structure in which the underwater moving vehicle 1 of the first embodiment is turned upside down. In other words, the screw propellers 21 are arranged at the bottom of the housing 20 and the window portion 28 is arranged at the top of the housing 20. The underwater moving vehicle 1A (vehicle body) of the second embodiment is set in advance such that its weight is smaller than the buoyant force generated in water. By adjusting the drive of the screw propellers 21 and generating the downward thrust corresponding to the difference between the weight and the buoyant force, the water depth of the underwater moving vehicle 1A can be kept constant. In addition, by decreasing the rotation speed of the screw propellers 21, the underwater moving vehicle 1 is raised. Conversely, by increasing the rotation speed of the screw propellers 21, the underwater moving vehicle 1 is lowered.

In the second embodiment, the four guide vanes 22 are provided directly above the screw propellers 21. By changing the orientation of these guide vanes 22, the upward water flow F generated by the screw propellers 21 is deflected. For instance, when the upward water flow F generated by the screw propellers 21 is deflected in one of the front, rear, right, and left directions, the underwater moving vehicle 1A can be moved in the direction A opposite to this deflected direction (FIG. 13).

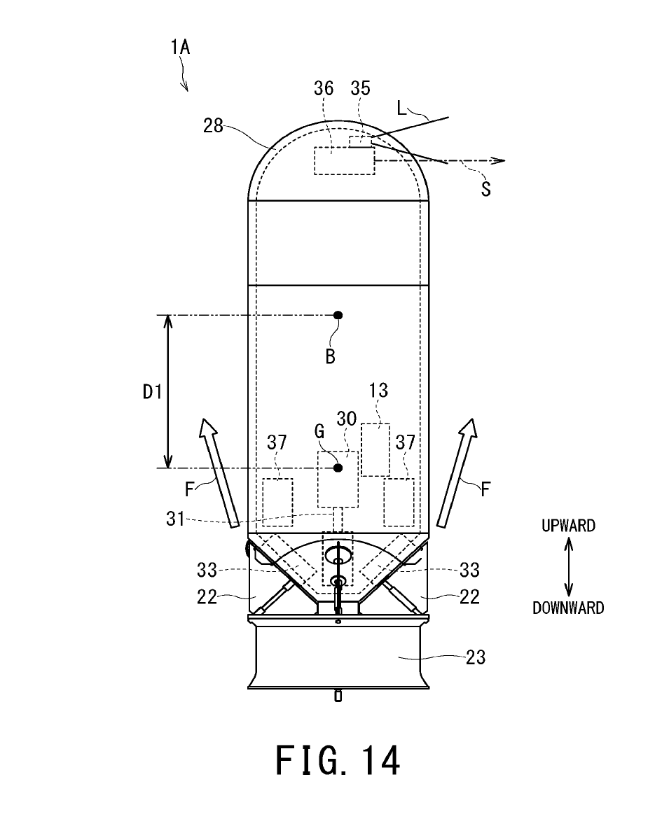

As shown in FIG. 14, in the second embodiment, the propeller driver 30 and the adjustment weights 37 are provided at positions close to the screw propellers 21, i.e., below the housing 20. The gravity center G of the underwater moving vehicle 1A is located on the lower side of the housing 20 by the weight of the propeller driver 30 and the adjustment weights 37. The gravity center G and the center B of buoyancy are spaced apart from each other by a predetermined distance D1.

In the second embodiment, when the buoyant force occurring in the underwater moving vehicle 1A is 10 kg, the adjustment weights 37 are reduced such that the weight of the underwater moving vehicle 1A becomes 9.5 kg. That is, the adjustment weight 37 is reduced in such a manner that the weight of the underwater moving vehicle 1 is 5% smaller than the buoyant force. For instance, the downward thrust generated by driving the screw propellers 21 (contra-rotating propellers 26) is assumed to be 1 kg at the maximum. In this case, under the assumption that the thrust generated by reducing the thrust of the screw propellers 21 to 50% is about its half (i.e., 0.5 kg), the adjustment weight 37 corresponding to 0.5 kg is removed.

In other words, in the underwater moving vehicle 1A of the second embodiment, when the thrust of the screw propellers 21 (contra-rotating propellers 26) is set to 50%, it is possible to generate the downward thrust corresponding to the difference between the weight and the buoyant force. In this state, the underwater moving vehicle 1A does not float or sink, and thus its water depth can be kept constant. Additionally, when the thrust of the screw propellers 21 is made larger than 50%, the downward thrust exceeding the difference between the weight and the buoyant force can be generated. Accordingly, it is possible to lower the underwater moving vehicle 1A. Further, when the thrust of the screw propellers 21 is made smaller than 50%, the downward thrust smaller than the difference between the weight and the buoyant force can be generated. Hence, the underwater moving vehicle 1A can be raised. In this manner, by controlling the drive of the screw propellers 21, it is possible to control the ascent and descent of the underwater moving vehicle 1A.

In the second embodiment, to reduce the thrust of the screw propellers 21 (contra-rotating propellers 26) to smaller than 50%, i.e., to generate the downward thrust smaller than the difference between the weight and the buoyant force includes stopping the drive (rotation) of the screw propellers 21 and setting the thrust to 0% (not to generate thrust).

In the second embodiment, the weight of the underwater moving vehicle 1 is made smaller than the buoyant force. Thus, when the underwater moving vehicle 1A fails and the drive of the screw propellers 21 stops, the underwater moving vehicle 1A is raised. Hence, when the underwater moving vehicle 1A fails, it is easy to retrieve the underwater moving vehicle 1A having been floated.

In the second embodiment, the underwater moving vehicle LA is configured such that its weight is 5% smaller than the buoyant force. However, it is sufficient that the weight of the underwater moving vehicle 1A is at least 3% smaller than the buoyant force. By satisfying this condition, even under the state where the water depth of underwater moving vehicle 1A is kept constant, the underwater moving vehicle 1A is continuously subjected to the thrust of the screw propellers 21 (contra-rotating propellers 26) having magnitude equivalent to the difference between the weight and the buoyant force, and thus the position of the underwater moving vehicle 1A can be stably maintained. In other words, the underwater moving vehicle 1A is pulled upward by the force that has magnitude equivalent to the difference between the weight and buoyant force, and is pushed down by the downward thrust of the same magnitude. Since the underwater moving vehicle 1A is continuously subjected to such forces, its position can be stably maintained.

The difference between the weight of the underwater moving vehicle 1A and the buoyant force may be appropriately changed depending on the thrust of the screw propellers 21. For instance, the weight of the underwater moving vehicle 1A may be smaller than the buoyant force by 10%, 20%, or 30%. In addition, the difference between the weight of the underwater moving vehicle 1A and the buoyant force is not necessarily required to be a value corresponding to 50% of the thrust of the screw propellers 21. For instance, the difference between the weight of the underwater moving vehicle 1 and the buoyant force may be a value corresponding to 30%, 40%, 60%, 70%, or 80% of the thrust of the screw propellers 21.

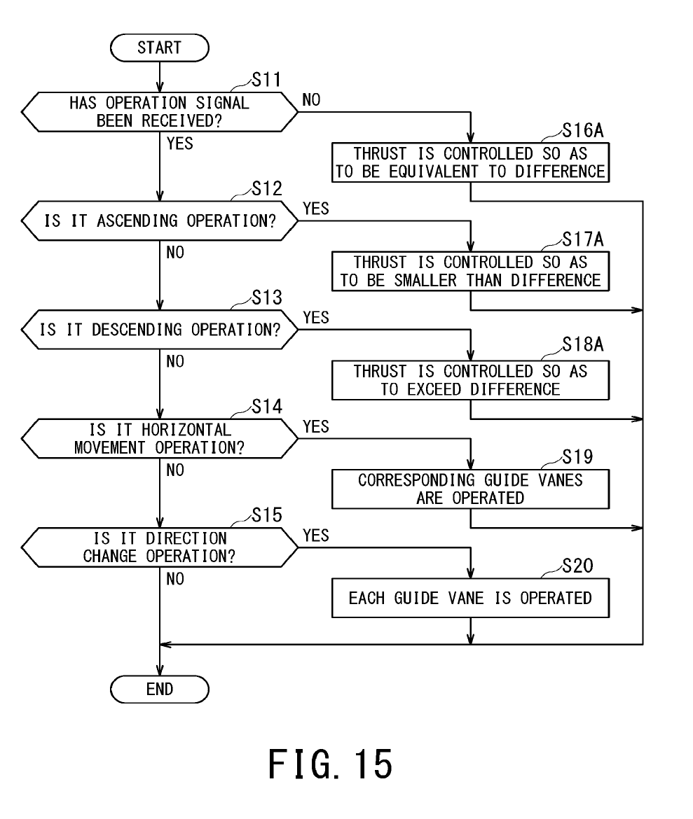

Next, by referring to FIG. 15, a description will be given of the underwater movement processing executed by the controller 13 (drive adjuster 50) of the underwater moving vehicle 1A of the second embodiment. In the underwater movement processing of the second embodiment, only the steps S16A, S17A and S18A are different from the underwater movement processing (FIG. 11) of the first embodiment, and the other steps are the same as those of the first embodiment.

In the second embodiment, in the setting step, the weight of the underwater moving vehicle 1A is previously set so as to be smaller than the buoyant force generated in water as described above. When the underwater moving vehicle 1A is submerged in the water, in the thrust step, the controller 13 generates the downward thrust corresponding to the difference between the weight of the underwater moving vehicle 1A and the buoyant force by driving the screw propellers 21.

As shown in FIG. 15, first, in the step S11, the controller 13 determines whether an operation has been received from the remote control PC or not, i.e., whether an operation signal has been received or not. When any operation is not received from the remote control PC, in the drive adjustment step S16A, the control is performed by keeping the rotation speed of the screw propellers 21 constant such that the downward thrust equivalent to the difference between the weight of the underwater moving vehicle 1A and the buoyant force is maintained and the water depth of the underwater moving vehicle 1A is kept constant. Then, the underwater movement processing is completed.

Conversely, when an operation is received from the remote operation PC, the processing proceeds to the step S12.

In the step S12, the controller 13 determines whether the received operation is the ascending operation or not.

When the received operation is the ascending operation, in the step S17A, the control is performed by decreasing the rotation speed of the screw propellers 21 such that the downward thrust smaller the difference between the weight of the underwater moving vehicle 1A and the buoyant force is generated and thereby the underwater moving vehicle 1A is raised. Then, the underwater movement processing is completed.

Conversely, when the received operation is not the ascending operation, the processing proceeds to the step S13.

In the step S13, the controller 13 determines whether the received operation is the descending operation or not. When the received operation is the descending operation, in the step S18A, the control is performed by increasing the rotation speed of the screw propellers 21 such that the downward thrust exceeding the difference between the weight of the underwater moving vehicle 1A and the buoyant force is generated and thereby the underwater moving vehicle 1A is lowered. Then, the underwater movement processing is completed.

Conversely, when the received operation is not the descending operation, the processing proceeds to the step S14. The subsequent steps are the same steps as the underwater movement processing of the first embodiment.

### Third Embodiment

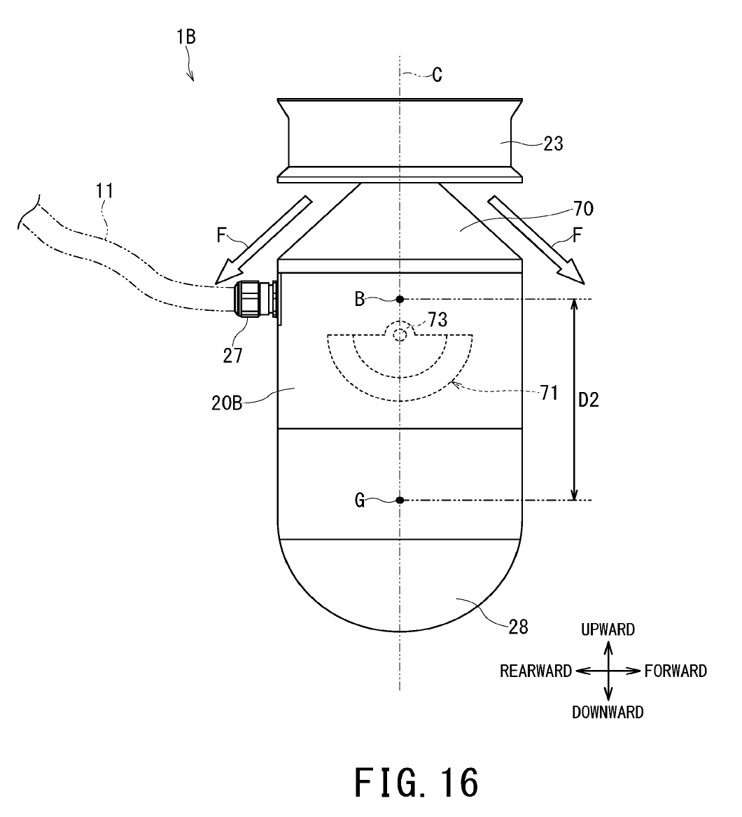

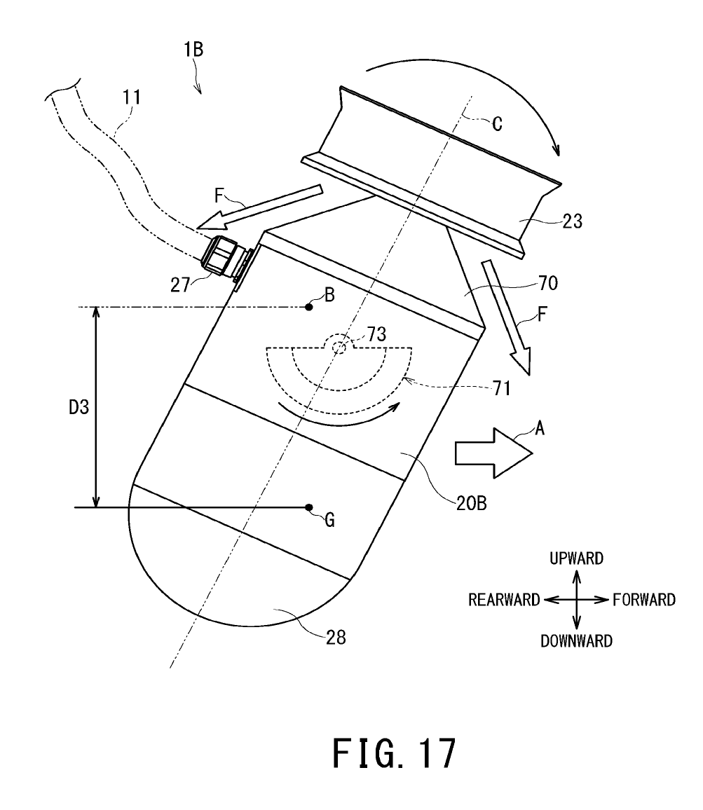

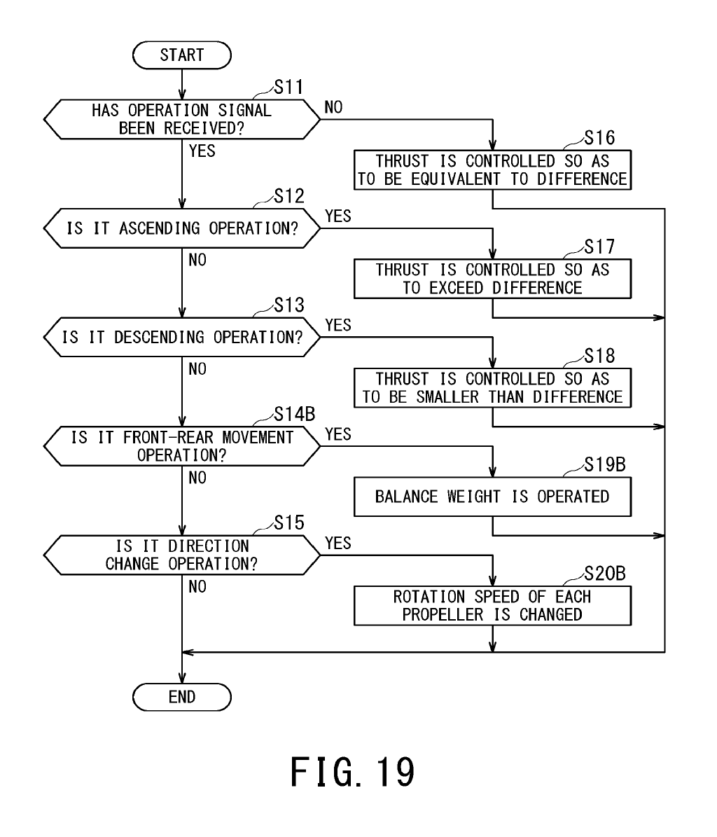

Next, the underwater moving vehicle 1B of the third embodiment will be described by referring to FIG. 16 to FIG. 19. Note that the same reference signs are assigned to the same components as the above-described embodiments, and duplicate description is omitted. In the following description, it is assumed that the right side of the sheet of each of FIG. 16 and FIG. 17 is the front side (i.e., anterior side) of the underwater moving vehicle 1B.

As shown in FIG. 16, the housing 20B of the underwater moving vehicle 1B of the third embodiment is shorter in the vertical direction than the housing 20 of the first embodiment. The distance D2 between the gravity center G and the center B of buoyancy of the underwater moving vehicle 1B is shorter than the distance D1 between the gravity center G and the center B of buoyancy in the first embodiment. For this reason, the housing 20B of the underwater moving vehicle 1B of the third embodiment is more easily inclined as compared with the housing 20 of the underwater moving vehicle 1 of the first embodiment.

Further, the Kort nozzle 23 (screw propellers 21) is disposed on the upper portion of the housing 20B. In the third embodiment, by driving the screw propellers 21, a downward water flow F is generated, and an upward thrust for the underwater moving vehicle 1B, i.e., a thrust of raising the underwater moving vehicle 1B is generated.

The underwater moving vehicle 1B (vehicle body) of the third embodiment is set in advance such that its weight is larger than the buoyant force generated in water. By adjusting the drive of the screw propellers 21 and generating the upward thrust equivalent to the difference between the weight and the buoyant force, the water depth of the underwater moving vehicle 1B can be kept constant. In addition, by increasing the rotation speed of the screw propellers 21, the underwater moving vehicle 1B is raised. Conversely, by decreasing the rotation speed of the screw propellers 21, the underwater moving vehicle 1B is lowered.

In the underwater moving vehicle 1B of the third embodiment, the guide vanes 22 of the first embodiment are not provided. The upper portion of the housing 20B of the third embodiment is a conical portion 70 formed in a conical shape. This conical portion 70 is provided immediately under the Kort nozzle 23 (screw propellers 21) and leads the downward water flow F generated by the screw propellers 21 downward.

In the third embodiment, the rotation speeds of the screw propellers 21 on the upper and lower sides of the contra-rotating propellers 26 (FIG. 5) are made different from each other in such a manner that the underwater moving vehicle 1B is turned around the shaft of the screw propellers 21.

For instance, as shown in FIG. 5, it is assumed that the upper screw propellers 21 rotate clockwise in plan view and the lower screw propellers 21 rotate counterclockwise in plan view. In the case of turning the underwater moving vehicle 1 clockwise in plan view, the rotation speed of the upper screw propellers 21 is reduced and the rotation speed of the lower screw propellers 21 is increased. In this case, by the reaction force of the lower screw propellers 21, the underwater moving vehicle 1B can be turned clockwise in plan view.

In the case of turning the underwater moving vehicle 1 counterclockwise in plan view, the rotation speed of the upper screw propellers 21 is increased and the rotation speed of the lower screw propellers 21 is reduced. In this case, by the reaction force of the lower screw propellers 21, the underwater moving vehicle 1B can be turned counterclockwise in plan view. In this manner, the underwater moving vehicle 1B can be turned by controlling the rotation speed of the screw propellers 21.

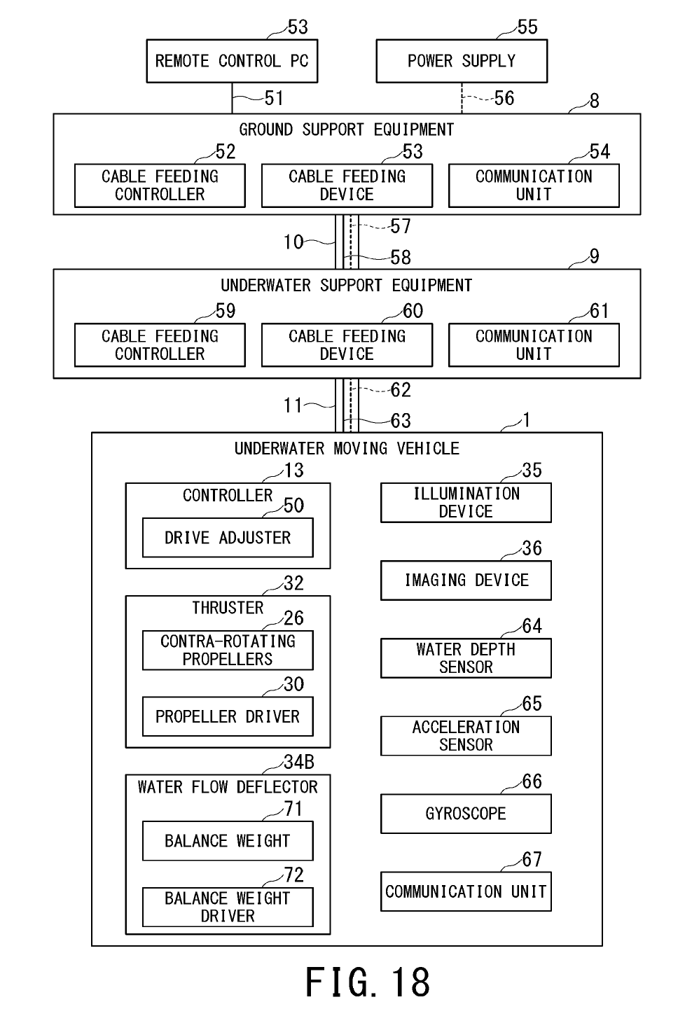

As shown in FIG. 17, when the thrust in the front-and-rear direction is generated with respect to the underwater moving vehicle 1B of the third embodiment, the center axis C of the underwater moving vehicle 1B is inclined. A balance weight 71 for changing the position of the gravity center G of the underwater moving vehicle 1B is provided inside the housing 20B of the underwater moving vehicle 1B. In addition, a balance weight driver 72 for driving the balance weight 71 is provided. The balance weight 71 and the balance weight driver 72 constitute the water flow deflector 34B of the third embodiment (FIG. 18).

Further, the balance weight 71 is a member having a semicircular shape in side view, and is capable of swinging in the front-and-rear direction around the swing shaft 73. In the case of advancing the underwater moving vehicle 1B, the balance weight 71 is driven so as to swing forward, and thereby the position of the gravity center G of the underwater moving vehicle 1B moves forward from the center axis C. In this manner, the center axis C of the underwater moving vehicle 1B is inclined forward. In other words, the screw propellers 21 are tilted so as to face forward. In this case, since the water flow F generated by the screw propellers 21 flows in a large amount toward the rear side, the underwater moving vehicle 1B is moved in the reverse direction A (i.e., forward direction). It should be noted that a part of the water flow F also flows to the front side and thus the underwater moving vehicle 1B never loses its balance.

In addition, in the case of moving the underwater moving vehicle 1B rearward, the balance weight 71 is driven so as to swing rearward and thereby the position of the gravity center G of the underwater moving vehicle 1B moves rearward from the center axis C. In this manner, the center axis C of the underwater moving vehicle 1B is inclined rearward. In other words, the screw propellers 21 are tilted so as to face rearward. In this case, since the water flow F generated by the screw propellers 21 flows in a large amount toward the front side, the underwater moving vehicle 1B is moved in the reverse direction A (i.e., rearward direction). It should be noted that a part of the water flow F also flows to the rear side and thus the underwater moving vehicle 1B never loses its balance.

In the third embodiment as described above, the water flow deflector 34B includes the balance weight 71 for keeping the attitude of the underwater moving vehicle 1B and the balance weight driver 72 for deflecting the water flow F by moving the balance weight 71 to tilt the attitude of the underwater moving vehicle 1B. Thus, by tilting the attitude of the underwater moving vehicle 1B, the water flow deflector 34B can deflect the water flow F generated by the screw propellers 21. In addition, since the number of operating components exposed to the outside like the guide vanes is reduced, the risk of damage can be reduced.

Since only the balance weight 71 configured to be swingable in the front-and-rear direction (one axis direction) is provided in the third embodiment, the underwater moving vehicle 1B can move forward and rearward but cannot move in the lateral direction (i.e., cannot move leftward or rightward). In the case of moving the underwater moving vehicle 1B to the left or right, the underwater moving vehicle 1B is turned in the direction to be moved and then is moved forward.

Next, by referring to FIG. 18, a description will be given of the underwater movement processing executed by the controller 13 (drive adjuster 50) of the underwater moving vehicle 1B of the third embodiment. In the underwater movement processing of the third embodiment, only the steps S14B, S19B, and S20B are different from the underwater movement processing (FIG. 11) of the first embodiment, and the other steps are the same as those of the first embodiment.

As shown in FIG. 18, in the step S14B, the controller 13 determines whether or not the received operation is a front-and-rear movement operation, i.e., an operation to move the underwater moving vehicle 1 in any one of the forward direction and the rearward direction. When the received operation is the front-and-rear movement operation, in the water flow deflection step S19B, the balance weight 71 is swung forward or rearward. For instance, in the case of advancing the underwater moving vehicle 1B, the balance weight 71 is swung forward, and the underwater moving vehicle 1B is inclined in such a manner that the screw propellers 21 face forward (FIG. 17). Then, the underwater movement processing is completed. When the operation signal of the front-and-rear movement operation is continuously received, the state in which the balance weight 71 is swung is continued. Conversely, when the received operation is not the front-and-rear movement operation, the processing proceeds to the step S15.

In the step S15, the controller 13 determines whether the received operation is the direction change operation or not, i.e., whether the operation is to turn the underwater moving vehicle 1B or not. When the received operation is the direction change operation, in the step S20B, by making the rotation speeds of the upper and lower screw propellers 21 different from each other, the underwater moving vehicle 1B is turned around the shaft of the screw propellers 21. Then, the underwater movement processing is completed. When the operation signal of the direction change operation is continuously received, the state in which the rotation speeds of the screw propellers 21 are made different from each other is continued. Conversely, when the received operation is not the direction change operation, the underwater movement processing is completed.

Although only the balance weight 71 capable of swinging in the front-and-rear direction (one axis direction) is provided in the third embodiment, a balance weight 71 capable of swinging in the right-and-left direction may be provided may be provided in addition to the balance weight 71 capable of swinging in the front-and-rear direction. In other words, it is possible to provide two balance weights 71, swinging directions of which are orthogonal to each other. By providing the respective balance weights 71 capable of swinging in the two axial directions in this manner, it is possible to horizontally move the underwater moving vehicle 1B in any of the four directions, i.e., forward, rearward, rightward, and leftward direction.

Although the underwater moving vehicles according to the present embodiment have been described on the basis of the first to third embodiments, the configuration applied in any one of the embodiments may be applied to other embodiments and the configurations applied in the respective embodiments may be used in combination.

For instance, the underwater moving vehicle 1B (vehicle body) of the third embodiment may be configured to be inverted upside down like the underwater moving vehicle 1A of the second embodiment such that its weight is set in advance so as to be smaller than the buoyant force generated in water. Further, by adjusting the drive of the screw propellers 21 and generating a downward thrust corresponding to the difference between the weight and the buoyant force, the water depth of the underwater moving vehicle 1B may be kept constant. Further, in the case of generating the thrust in the front-and-rear direction, the center axis C of the underwater moving vehicle 1B may be inclined.

Although the underwater moving vehicle 1 is used for investigation inside the reactor pressure vessel 2 in the present embodiment, the underwater moving vehicle 1 may be used for investigation inside another structure. For instance, the underwater moving vehicle 1 may be used for investigating the inside space of a closed structure such as the inside of a water pipe and/or a water storage tank. In addition, the underwater moving vehicle 1 may be used for investigations other than artificial structures. For instance, the underwater moving vehicle 1 may be used for investigating a river, a pond, a lake, and the ocean.

Although the cable 11 is connected to the underwater moving vehicle 1 and the underwater moving vehicle 1 is operated by wire with the use of this cable 11 in the present embodiment, the underwater moving vehicle 1 may be wirelessly operated without connecting the underwater moving vehicle 1 to the cable 11. In addition, the underwater moving vehicle 1 may be configured to autonomously move in water. Further, the underwater moving vehicle 1 may be a submersible ship on which an operator boards and operates it.

Although the underwater moving vehicle 1 performs investigation by imaging the inside of the reactor pressure vessel 2 in the present embodiment, the underwater moving vehicle 1 may have other functions. For instance, a robotic arm may be mounted on the underwater moving vehicle 1 for collecting a structure or the like. Additionally or alternatively, a water absorbing device may be mounted on the underwater moving vehicle 1 for collecting the water inside the reactor pressure vessel 2.

Although one main thruster composed of the contra-rotating propellers 26 (two screw propellers 21) is provided in the present embodiment, plural main thrusters may be provided. For instance, four small main thrusters may be arranged in the same direction such that an upward thrust or downward thrust is generated by using these main thrusters.

In the first embodiment or the third embodiment, the screw propellers 21 draw water from above and generate a downward water flow F. However, water may be sucked in from the side of the housing 20 so as to be discharged as the water flow F downward from below the housing 20. Although the screw propellers 21 suck in water from below so as to generate an upward water flow F in the second embodiment, the screw propellers 21 may suck water from the side of the housing 20 so as to discharge an upward water flow F from above the housing 20. In addition, it is not necessarily required that the screw propellers 21 are exposed to the outside of the housing 20. The underwater moving vehicle may be configured such that water sucked through an intake port provided in the housing is lead to the screw propellers through a duct inside the housing and thereby a water flow is discharged from a discharge port provided in the housing to generate a thrust.

According to the above-described embodiments, the underwater moving vehicle 1 is provided with the water flow deflector 34 that adjusts the drive of the screw propellers 21 and generates a vertical (upward or downward) thrust equivalent to the difference between the weight of the underwater moving vehicle 1 and buoyant force so as to keep the water depth of the underwater moving vehicle 1 constant. Additionally or alternatively, the underwater moving vehicle 1 includes: the drive adjuster 50 configured to move the underwater traveling vehicle 1 to a predetermined position; and the water flow deflector 34 configured to move the underwater moving vehicle 1 in the horizontal direction by deflecting the water flow F in the vertical direction (upward or downward) generated by the screw propeller 21. Thus, it is possible to improve the motion performance of the underwater moving vehicle 1 and to stably keep the position of the underwater moving vehicle 1.

While certain embodiments have been described, these embodiments have been presented byway of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### REFERENCE SIGNS LIST

1 (1A, 1B) underwater moving vehicle
2 reactor pressure vessel
3 core shroud
4 core support
5 jet pump
6 control rod guide tube
7 control rod drive mechanism
8 ground support equipment
9 underwater support equipment
10 cable
11 cable
12 remote control PC
13 controller
20 (20B) housing
21 screw propeller
22 guide vane
23 Kort nozzle
24 rotation shaft
25 blade
26 contra-rotating propellers
27 cable connecting portion
28 window portion
30 propeller driver
31 drive shaft
32 thruster
33 guide vane driver
34 (34B) water flow deflector
35 illumination device
36 imaging device
37 adjustment weight
40 arrangement surface
41 support rod
42 wall
43 first magnet
44 first magnetic-force linkage unit
45 second magnet
46 second magnetic-force linkage unit
47 swinging rod
48 solenoid portion
50 drive adjuster
51 communication line
52 cable feeding controller for support device
53 cable feeding device for support device
54 communication unit
55 power supply
56 power supply line
57 power supply line
58 communication line
59 cable feeding controller for vehicle
60 cable feeding device for vehicle
61 communication unit
62 power supply line
63 communication line
64 water depth sensor
65 acceleration sensor
66 gyroscope
67 communication unit
70 conical portion
71 balance weight
72 balance weight driver
73 swing shaft

1. An underwater moving vehicle comprising:
a vehicle body configured to be set in advance in such a manner that weight of the vehicle body becomes larger than buoyant force generated in water;
a thruster configured to generate an upward thrust by driving screw propellers;
a drive adjuster configured to control water depth of the vehicle body to a predetermined position by adjusting drive of the screw propellers and generating the upward thrust equivalent to difference between the weight and the buoyant force; and
a water flow deflector configured to move the vehicle body in a horizontal direction by deflecting a downward water flow generated by the screw propellers.

2. The underwater moving vehicle according to claim 1,
wherein the drive adjuster is configured to
raise the vehicle body by generating the upward thrust exceeding the difference, and
lower the vehicle body by generating the upward thrust smaller than the difference.

3. The underwater moving vehicle according to claim 1,
wherein the water flow deflector includes:
at least two guide vanes configured to guide water flow; and
a guide vane driver configured to deflect the water flow by changing directions of the guide vanes.

4. The underwater moving vehicle according to claim 1,
wherein the water flow deflector includes:
a balance weight configured to keep attitude of the vehicle body; and
a balance weight driver configured to deflect the water flow by moving the balance weight and tilting the attitude of the vehicle body.

5. The underwater moving vehicle according to claim 1, further comprising contra-rotating propellers in which two sets of the screw propellers are coaxially arranged and rotate in directions opposite to each other.

6. The underwater moving vehicle according to claim 1, further comprising a water depth sensor configured to detect water depth,
wherein the drive adjuster is configured to keep the water depth of the vehicle body constant by controlling a rotation speed of the screw propellers to a rotation speed corresponding to the water depth detected by the water depth sensor.

7. The underwater moving vehicle according to claim 1,
wherein the vehicle body is configured to maintain a rotation axis of the screw propellers vertical by locating a gravity center below a center of buoyancy.

8. An underwater moving vehicle comprising:
a vehicle body configured to be set in advance in such a manner that weight of the vehicle body becomes smaller than buoyant force generated in water;
a thruster configured to generate a downward thrust by driving screw propellers;
a drive adjuster configured to control water depth of the vehicle body to a predetermined position by adjusting drive of the screw propellers and generating the downward thrust equivalent to difference between the weight and the buoyant force; and
a water flow deflector configured to move the vehicle body in a horizontal direction by deflecting an upward water flow generated by the screw propellers.

9. The underwater moving vehicle according to claim 8,
wherein the drive adjuster is configured to
raise the vehicle body by generating the downward thrust smaller the difference, and
lower the vehicle body by generating the downward thrust exceeding than the difference.

10. The underwater moving vehicle according to claim 8,
wherein the water flow deflector includes:
at least two guide vanes configured to guide water flow; and
a guide vane driver configured to deflect the water flow by changing directions of the guide vane.

11. The underwater moving vehicle according to claim 8,
wherein the water flow deflector includes:
a balance weight configured to keep attitude of the vehicle body; and
a balance weight driver configured to deflect the water flow by moving the balance weight and tilting the attitude of the vehicle body.

12. The underwater moving vehicle according to claim 8, further comprising contra-rotating propellers in which two sets of the screw propellers are coaxially arranged and rotate in directions opposite to each other.

13. The underwater moving vehicle according to claim 8 further comprising a water depth sensor configured to detect water depth,
wherein the drive adjuster is configured to keep the water depth of the vehicle body constant by controlling a rotation speed of the screw propellers to a rotation speed corresponding to the water depth detected by the water depth sensor.

14. The underwater moving vehicle according to claim 8,
wherein the vehicle body is configured to maintain a rotation axis of the screw propellers vertical by locating a gravity center below a center of buoyancy.
